(19) United States
(12) Patent Application Publication
(10) Pub. No.: US 2007/0248846 A1
(43) Pub. Date: Oct. 25, 2007

(54) Method for Producing Membrane-Electrode Units

(75) Inventors: Claus-Rupert Hohenthanner, Hanau (DE); Marco Lopez, Frankfurt (DE); Joachim Koehler, Gruendau/Haingruendau (DE)

Correspondence Address: KALOW & SPRINGUT LLP, 488 MADISON AVENUE, 19TH FLOOR, NEW YORK, NY, 10022, US

(73) Assignee: UMICORE AG & CO KG, hanau-Wolfgang (DE)

(21) Appl. No.: 11/661,558

(22) PCT Filed: Aug. 27, 2005
(86) PCT No.: PCT/EP05/09257

§ 371 Date: Jun. 11, 2007

(30) Foreign Application Priority Data
Aug. 28, 2004 (EP) 04020485.1

(51) Int. Cl. H01M 8/00; B05D 5/12

(52) U.S. Cl. 429/12; 29/592.1; 427/77

(57) ABSTRACT

The invention relates to a process for producing a five-layer membrane-electrode unit comprising an ionomer membrane, a first catalyst layer, a second catalyst layer, a first gas diffusion layer and a second gas diffusion layer. In the process of the invention, at least one gas diffusion layer is provided with a suitable perforation grid before or after coating with the catalyst. The excess gas diffusion material is removed as pressed screen after lamination of the gas diffusion layer onto the membrane, exposing the uncoated membrane areas. The process is suitable for the continuous production of five-layer membrane-electrode units of type 1 (in which the membrane forms a rim projecting beyond the two gas diffusion layers) and of type 3 (in which gas diffusion layers and membrane have a step-like, semicoextensive design). Two process variants in which dried and undried (i.e. solvent-containing) catalyst layers are laminated onto the membrane are described. The five-layer membrane-electrode units produced are used in electrochemical devices such as PEM fuel cells, direct methanol fuel cells (DMFCs) or electrolysers.

The invention relates to the technical field of electrochemistry and describes a process for producing a membrane-electrode unit (MEU) for electrochemical devices such as fuel cells, electrochemical sensors or electrolysers. The membrane-electrode unit of the invention is preferably used in membrane fuel cells, for example PEM fuel cells (PEMFCs) or direct methanol fuel cells (DMFCs).

Fuel cells convert a fuel and an oxidant at separate locations at two electrodes into electric current, heat and water. As fuel, it is possible to employ hydrogen, methanol or a hydrogen-rich gas, and the oxidant can be oxygen or air. The energy conversion process in the fuel cell is highly pollutant-free and has a particularly high efficiency. For this reason, fuel cells are becoming increasingly important for alternative drive concepts, domestic energy supply plants and also portable applications.

Membrane fuel cells, for example the polymer electrolyte fuel cell (PEMFC) and the direct methanol fuel cell (DMFC) are, owing to their low operating temperature, their compact construction and their power density, suitable for mobile, stationary and portable applications.

PEM fuel cells are made up of a stack of many fuel cell units. These are electrically connected in series to increase the operating voltage. The key component of a PEM fuel cell is the membrane-electrode unit (MEU). The MEU comprises the proton-conducting membrane (polymer electrolyte membrane or ionomer membrane), the two gas diffusion layers (GDLs) on the sides of the membrane and the electrode layers located between membrane and gas diffusion layers. One of the electrode layers is configured as anode for the oxidation of hydrogen and the second electrode layer is configured as cathode for the reduction of oxygen.

The polymer electrolyte membrane comprises proton-conducting polymer materials. These materials will hereinafter also be referred to as ionomers for short. Preference is given to using a tetrafluoroethylene-fluorovinyl ether copolymer bearing sulphonic acid groups. This material is, for example, marketed under the trade name Nafion® by DuPont. However, other, in particular fluorine-free, ionomer materials such as doped sulphonated polyetherketones or doped sulphonated or sulphinated aryl ketones or polybenzimidazoles can also be used. Suitable ionomer materials are described by O. Savadogo in “Journal of New Materials for Electrochemical Systems” I, 47-66 (1998). For use in fuel cells, these membranes generally need to have a thickness in the range from 10 to 200 μm.

The electrode layers for anode and cathode generally contain electrocatalysts which catalyze the respective reaction (oxidation of hydrogen or reduction of oxygen). As catalytically active components, preference is given to using the metals of the platinum group of the Periodic Table of the Elements. In the majority of cases, supported catalysts, in which the catalytically active platinum group metals have been applied in finely divided form to the surface of a conductive support material, for example carbon black are used.

The gas diffusion layers (GDLs) usually consist of porous carbon-based materials and make it possible for the reaction gases to gain ready access to the reaction layers and allow the cell current and the water formed to be conducted away readily. Suitable materials are graphitized or carbonized carbon fibre papers, carbon fibre nonwovens and woven carbon fibre fabrics from Toray (Japan), Textron (USA) or SGL-Carbon (Germany). The gas diffusion layer can have been hydrophobicized and/or have an evening layer (“microlayer”).

In the production of MEUs, a fundamental distinction is made between the following two principles:
a) coating of the membrane with the catalyst to give a catalyst-coated membrane (CCM)
b) coating of the gas diffusion layers with the catalyst to give electrodes (catalyst-coated backings or “CCBs”) and subsequent joining of the electrodes to the membrane by pressing.

The direct coating of the membrane with catalyst can be carried out either wet by means of a paste or ink or dry by means of a powder or a decal. Coating of the gas diffusion layers (GDLs) with the catalyst can likewise be carried out wet by means of a paste or ink or dry, for example by means of a powder. Bonding of the dried catalyst layer to the GDL on the membrane is achieved by means of pressure and heat in a further process step, e.g. by pressing and/or rolling. When powders are used, the catalyst is likewise bonded to the membrane by means of pressure and heat. The paste, ink or powder comprise the catalyst component together with, if appropriate, ionomers and other auxiliaries as binders.

The two processes a) and b) have advantages and disadvantages. Direct coating of an unsupported membrane with a solvent-containing catalyst paste usually leads to uncontrolled swelling during coating and shrinkage in the subsequent drying process. For this reason, only simple geometries can be produced at high tolerances. In addition, the swelling and shrinkage can lead to wrinkles in the uncoated edge region, which makes sealing of the MEU between the bipolar plates more difficult.

Methods of minimizing or controlling this swelling and shrinkage in direct membrane coating are described in the literature:

EP 1 037 295 discloses a continuous process for the selective application of electrode layers to an ionomer membrane in tape form, in which the front and reverse sides of the membrane are printed. The membrane has to have a certain water content (from 2 to 20% by weight).

In WO 02/43171, an attempt is made to introduce only very little solvent per coating step by application of numerous very thin layers with subsequent drying, so that the membrane undergoes only minimal swelling.

In U.S. Pat. No. 6,074,692, the membrane is swelled in the solvent prior to coating. This makes the entire swollen membrane able to take up forces uniformly and be easier to handle.

EP 1 262 057 A1 describes a method for manufacture of a membrane electrode unit wherein hydrophobicized carbon substrates, which carry wet catalyst layers, are placed on the opposite sides of a ionomer membrane. Thereafter a firm bond is made.

In EP 1 262 057 A1 a method for manufacture of a membrane electrode unit is disclosed, in which the catalyst layers are subsequently brought into contact with the ionomer membrane, whereby the corresponding opposite side of the membrane is supported.

EP 1 369 948 A1 describes the manufacture of five-layer membrane electrode units in a lamination process with the use of an adhesive component.

Depending on the design of the PEM stack, the bipolar plate or the type of sealing concept, membrane-electrode units (MEUs) can have a different basic design. In the case of five-layer MEUs, the following three design types are conceivable:

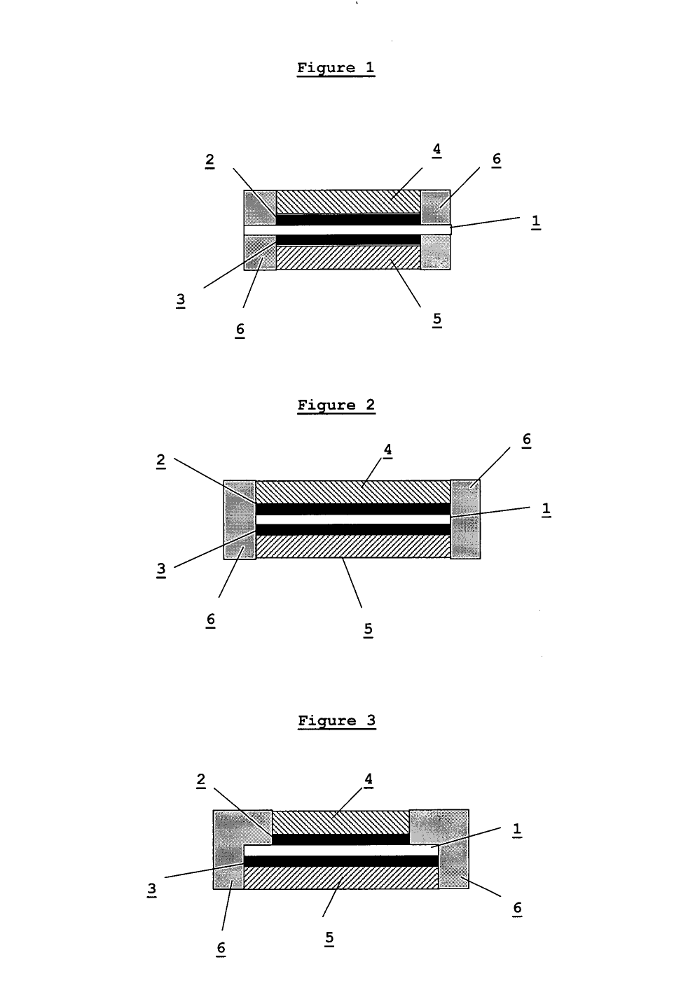

MEU Type 1 (cf. FIG. 1)

This MEU design (type 1) has five layers and is characterized in that the ionomer membrane (1) forms a rim projecting beyond the two gas diffusion layers (4) and (5). The catalyst layer (2) is located between the membrane (1) and the gas diffusion layer (4), and the catalyst layer (3) is located between the gas diffusion layer (5) and the membrane (1). The MEU can optionally be provided with sealing material (6). The rim, which may be coated with catalyst or uncoated, is clamped between the bipolar plates and, if necessary, between further seals during sealing of the cell. The projecting membrane can be reinforced by a protective film (cf., for example, U.S. Pat. No. 3,134,697, EP 1 403 949 A1).

MEU Type 2 (cf. FIG. 2)

This MEU design, also referred to as “coextensive design” is characterized in that the membrane (1) is covered essentially completely by the two gas diffusion layers (4) and (5) on both surfaces. The catalyst layers (2) and (3) frequently have the same dimensions as the GDLs. A sealing rim (6) can be provided around the circumference of the MEU. This design is described, for example, in U.S. Pat. No. 6,057,054 and EP 966 770 B1).

MEU Type 3 (cf. FIG. 3)

This MEU design, also referred to as “semicoextensive design” has a step-like rim and is characterized in that a first gas diffusion layer (4) has a smaller area than the polymer electrolyte membrane (1) and the second gas diffusion layer (5) essentially matches the membrane: the catalyst layers generally have the same dimensions as the respective GDLs. On this subject, cf. FIG. 3 as well as the International Patent application WO 05/006473 A2 of the applicant.

MEUs of type 1 tend to be sensitive to mechanical damage to the membrane during production and assembly. The use of thin membranes (having thicknesses of about 25 μm) makes the rim still more sensitive. Continuous production of the products in roll-to-roll processes leads to considerable problems since free, flexible and slightly extendable membrane pieces alternate with stiff and thick multilayer pieces at short intervals on a roll. This makes control of the sheet speed and the handling of the material flow virtually impossible.

MEUs of type 1 can also be produced as described in EP 868 760 B1. Here, precut pieces of carbon nonwoven are applied to a mesh. Two of these mesh structures are then laminated onto the front and reverse sides of the membrane; the five-layer MEUs are subsequently cut apart. The process is cumbersome, expensive and time-consuming.

Coextensive MEUs (design type 2) can be produced simply and inexpensively in a roll process, cf. EP 868 760 B1 as above. This patent describes a process for producing membrane-electrode units in which the joining of the polymer electrolyte membrane, the electrode layers and the gas diffusion layers (GDLs) is carried out continuously in a roller process. However, in the coextensive design, the poles of the fuel cell are separated at their edge by only a few 10 μm. During cutting of the units from a strip and other subsequent processing steps, there is a risk of the electrodes being short-circuited by fibres from the gas diffusion layers. For this reason, the stepwise semicoextensive design (type 3) has advantages.

No processes for producing the semicoextensive MEU products of type 3 have hitherto been disclosed. In addition, only expensive and cumbersome processes have been described for producing MEUs of type 1.

It is therefore an object of the present invention to provide a manufacturing process for membrane-electrode units having an unreinforced rim projecting on both sides (design type 1) and for membrane-electrode units having a step-like rim (cf. semicoextensive design type 3). The process should be able to be carried out simply, inexpensively and rationally and make large-scale industrial production of these products possible.

This object is achieved by provision of a process according to Claim 1. Advantageous further embodiments are described in the subordinate claims. Further claims relate to the use of the catalyst-coated polymer electrolyte membranes produced by the process.

The present invention describes a process for producing a five-layer membrane-electrode unit comprising an ionomer membrane, a first catalyst layer, a second catalyst layer, a first gas diffusion layer and a second gas diffusion layer, which comprises the following steps:
a) coating of the two gas diffusion layers with catalyst
b) perforation of at least one gas diffusion layer in a suitable grid
c) lamination of the two gas diffusion layers with the ionomer membrane
d) removal of the at least one pressed screen from the surface of the ionomer membrane and cutting-off of the membrane-electrode unit.

It is important that at least one gas diffusion layer is perforated in a suitable grid either before or after coating with catalyst. After lamination has been carried out, the excess gas diffusion material is removed in the form of a “pressed screen”, with the uncoated membrane areas being exposed.

It has been surprisingly found that in the method of the present invention this “pressed screen” can be removed easily and completely.

It has further been found that membrane-electrode units of the design types 1 and 3 can be produced simply and rationally by means of this process. If dimensions of the pressed screen are minimized, the consumption of material for the gas diffusion layers can also be reduced. The various embodiments of the process of the invention are described below.

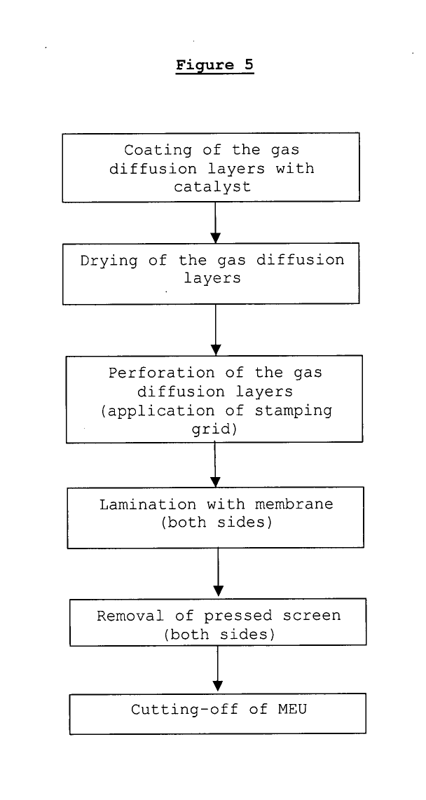

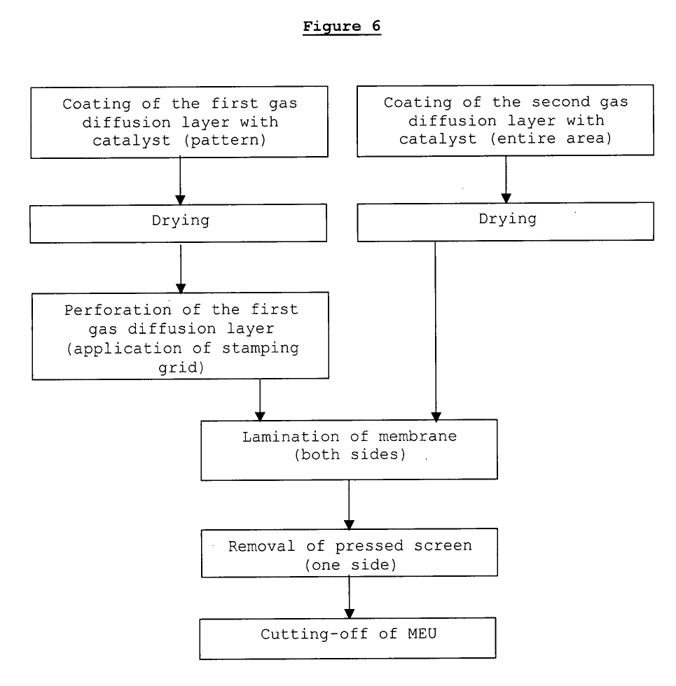

The first embodiment of the process relates to the production of a five-layer MEU of type 1 or of type 3 by means of the “dry electrode process” (cf. FIGS. 5 and 6).

In this process, the catalyst is applied as paste or ink to the stiff and nonswelling gas diffusion layers and subsequently dried. To produce an MEU of type 1 by the dry electrode process (cf. FIG. 5), the catalyst layers (2) and (3) are applied in the form of motifs or patterns to the two gas diffusion layers (4) and (5). The catalyst layers on the gas diffusion layers (4) and (5) are subsequently dried and, if appropriate, after-treated. In the next step, a perforation grid is stamped onto the two coated gas diffusion layers (4), (5) (“perforation”), preferably in the dimensions of the active, catalyst-coated motif or pattern. The two gas diffusion layers which have been perforated in this way are subsequently laminated with the membrane (1). After lamination has been carried out, the excess material of the gas diffusion layers is removed in the form of pressed screens from front and reverse sides of the membrane and the structure is cut up into five-layer MEUs. In the production of five-layer MEUs of type 1, the two gas diffusion layers (4) and (5) which have been coated with motifs have to be aligned both in the longitudinal direction and in the transverse direction by means of alignment marks in order to ensure good accuracy of fit.

To produce an MEU of type 3 by the dry electrode process (cf. FIG. 6), the catalyst layer is applied as a discrete motif or pattern only to the first gas diffusion layer (4). The catalyst layer is applied over the entire area (i.e. without a discrete motif or pattern) of the second gas diffusion layer (5). After drying and possibly an after-treatment step, a perforation grid is punched around the discrete motifs of the first gas diffusion layer (4). The two substrates, the perforated gas diffusion layer (4) and the unperforated gas diffusion layer (5) are subsequently laminated with the membrane (1). After lamination has been carried out, the pressed screen is removed from the gas diffusion layer (4) on the upper side of the membrane and the structure is cut up to give five-layer MEUs.

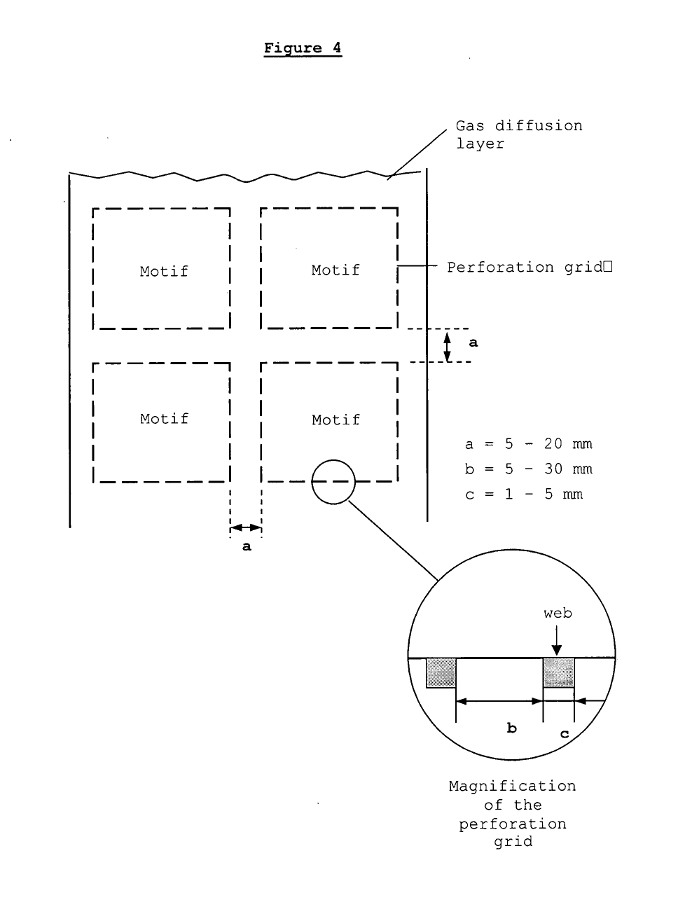

As shown in FIG. 4, the perforations (or slits) on the gas diffusion layers typically have dimensions (b) in the range from about 5 to 30 mm. The typical slit widths are from 0.1 to 1 mm. The nonperforated webs have dimensions (c) in the range from about 1 to 5 mm. The spacing (a) of the separate motifs or perforation grid on the gas diffusion layer is from about 5 to 20 mm. However, the shape and dimensions of the perforation grid are very greatly dependent on the GDL material used and can vary considerably. It is important that the pressed screen can be removed easily after lamination so as to expose the uncoated membrane area. The pressed screen to be removed can, for example, also be reinforced by means of applied films. This prevents tearing of the pressed screen on removal.

To carry out the perforation procedure, it is possible to use perforation tools such as knives, impact cutters, stamping tools, perforation rollers, etc. Perforation or stamping can be carried out either continuously (i.e. integrated into a continuous production line) or discontinuously (i.e. in a separate apparatus).

The perforation step can in principle be carried out before or after coating of the gas diffusion layer with catalyst. If perforation is carried out before coating, the catalyst layer is preferably applied to the surface on which the perforation grid is present.

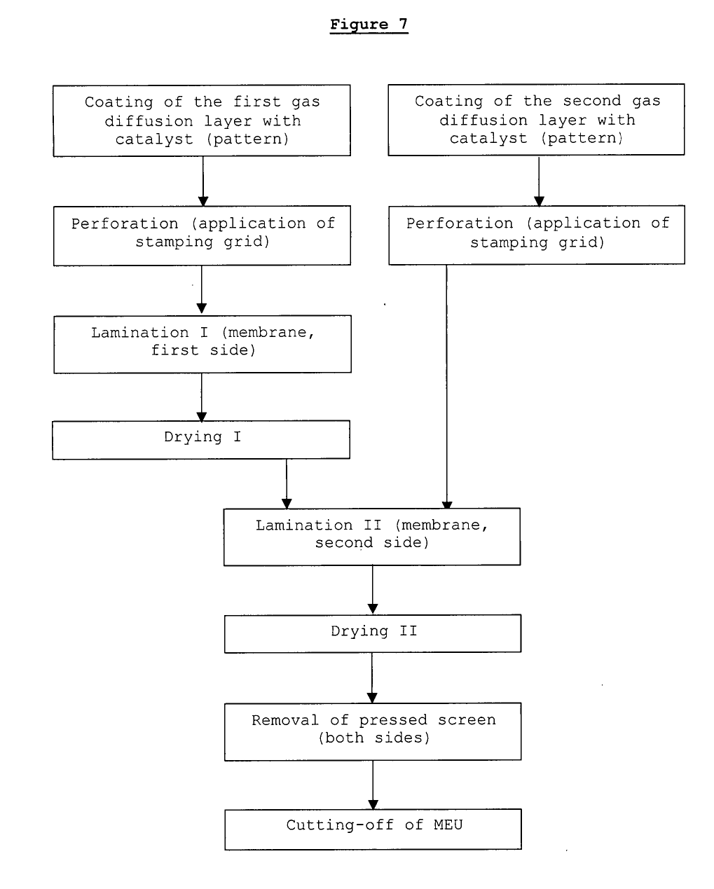

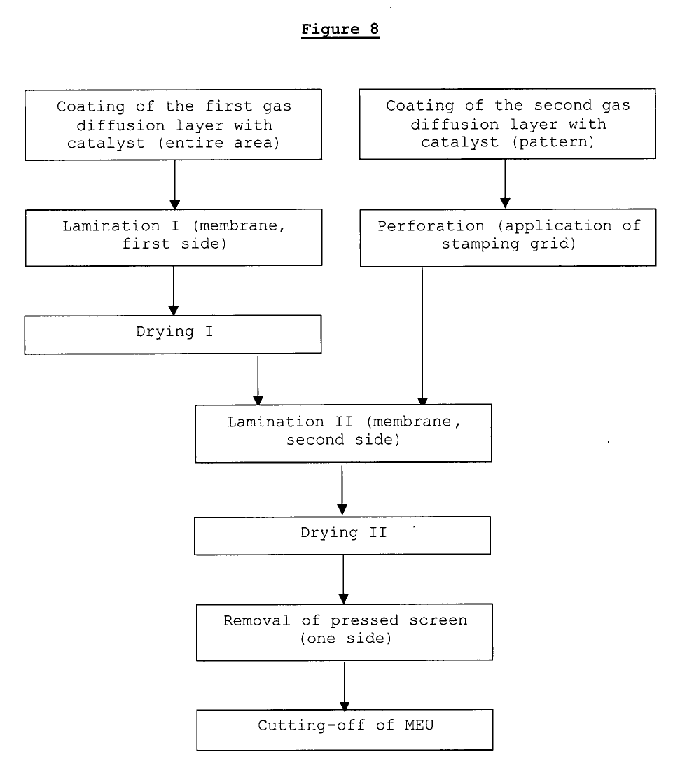

A second embodiment of the present invention relates to the production of a five-layer MEU of type 1 or of type 3 by the “wet electrode process” (cf. FIGS. 7 and 8).

In the methods of MEU production described above, the catalyst is bonded to the ionomer membrane physically by means of pressure and/or heat. Very thin membranes in particular are stressed severely between the electrodes in the lamination step. Apart from pure mechanical bonding of the catalyst layer to the membrane, bonding can also be achieved by a chemical route or by means of a combination of the two methods. In these variants, the membrane experiences lower mechanical and thermal stresses.

In this second embodiment of the process of the invention, the catalyst is applied as paste or ink to the stiff and nonswelling gas diffusion layers. The membrane is laminated into the wet catalyst layer, and the composite is subsequently dried. Gas diffusion layers and membrane are preferably present in strip form, and lamination and drying can be carried out in a multistage procedure. The ionomer membrane can be supported on the side facing away from the gas diffusion layer by a plastic film (e.g. a 50 μm thick polyester film) to improve handling.

In the production of a five-layer MEU of type 1 by the wet electrode process (cf. FIG. 7), the gas diffusion layers (4) and (5) are coated with the catalyst layers (2) and (3), respectively, in a discrete motif or pattern, and the two substrates are subsequently perforated in a suitable pattern.

Lamination of the two gas diffusion layers with the membrane and subsequent drying are preferably carried out in a two-stage process. Firstly, the gas diffusion layer (5) is laminated together with the still moist catalyst layer onto the membrane (1) in a first lamination step (“lamination I”), and this three-layer structure is then dried (“drying I”). The perforated gas diffusion layer (4) which is coated in a discrete pattern with moist catalyst layer (2) is subsequently laminated onto the three-layer composite (“lamination II”) and subsequently dried (“drying II”). The pressed screen is then removed from both sides of the membrane and the structure is cut up to give five-layer MEUs.

In the production of a five-layer MEU of type 3 by the wet electrode process (cf. FIG. 8), the gas diffusion layer (5) is coated over its entire area with catalyst layer (3) and is subsequently laminated in the moist state onto the membrane (1) (“lamination I”). The three-layer composite is then dried (“drying I”). The second gas diffusion layer (4) is perforated and coated in a suitable pattern with catalyst layer (2). The coated gas diffusion layer (4) is subsequently once again laminated with the three-layer composite (“lamination II”), followed by a further drying step (“drying II”). After removal of the pressed screen from one side, the structure is cut up into individual MEUs.

Before lamination, motifs which have the same size as the motifs on the second gas diffusion layer can optionally also be applied by means of the catalyst ink to the free membrane area of the previously produced three-layer composite of gas diffusion layer (5)/catalyst layer (3)/membrane (1). In this way, it is possible to obtain, for example, catalyst layers having a higher precious metal loading. A membrane can likewise be provided on the side facing the gas diffusion layer with a catalyst layer (as motif or as full-area strips).

In principle, it is also possible to use supported ionomer membranes for the process of the invention.

After lamination and drying, the membrane is supported by the composite with the gas diffusion layer so that any support film present on the membrane can be removed easily.

In all process variants described here, lamination is preferably carried out continuously by means of rollers or belt presses or intermittently by means of presses which can either be heated or unheated. The roller or the presses can have raised profiles having the size of the printed motifs in order to avoid lamination of the webs which are not coated with the catalyst.

The forces in lamination into the wet catalyst layers are significantly lower than the forces required for lamination of the membrane into the dry catalyst layers of electrodes.

Lamination can be followed by further after-treatment steps, for example cleaning steps to remove residual solvents from the catalyst layers or membrane reprotonation steps.

Lamination or pressing requires temperatures in the range from about 90 to 200° C. and pressures in the range from 100 to 300 N/cm². In the case of belt pressing or hot pressing, the residence times are in the range from about 5 to 120 seconds. In the case of hot rolling, line loads in the range from 50 to 300 N/cm are required. The rollers have a diameter of from about 100 to 500 mm; rolling is carried out at a belt speed in the range from 0.5 to 20 m/min.

Typical dimensions of the gas diffusion layers, membranes and electrodes are widths of from 100 to 1000 mm, preferably from 100 to 500 mm. Preference is given to using roll material having lengths of more than 10 m. For discontinuous operation, preference is given to using sheets having dimensions of up to 500×500 mm.

The catalyst layers on the two sides of the MEU can be different from one another. They can be made up of different catalyst inks and have different proportions of catalyst or precious metal loadings (mg of p.m./cm²). The paste or ink can contain organic solvents or be water-based. The catalyst layers can contain the precious metals platinum, ruthenium, iridium, osmium, gold, palladium, silver, rhodium or mixtures or alloys thereof. The precious metal loading of the catalyst layers is in the range from 0.05 to 10 mg of precious metal/cm². Preferred electrocatalysts are supported catalysts containing precious metals, for example Pt or PtRu catalysts, and also unsupported blacks.

The coating of the gas diffusion layers with catalyst paste can be effected by means of the known coating methods such as screen printing (e.g. flat bed or rotational screen printing), offset printing, transfer printing, doctor blade coating, spraying, flexo printing, roller coating (e.g. by means of a roller coater), etc. Typical coating speeds in the continuous process are from 1 to 20 m/min.

Suitable apparatuses for continuous processing, the coating and lamination of strip-like substrates in the roll-to-roll process are known to those skilled in the art. Ionomer membranes comprising polymeric, perfluorinated sulphonic acid compounds (for example Nafion®), doped polybenzimidazoles, polyether ketones or polysulphones both in the acid form and in the alkali form can be processed by means of such processes. Composite membranes and ceramic membranes can also be used.

Suitable drying methods are, inter alia, hot air drying, infrared drying, microwave drying, plasma processes and/or combinations of these methods. The drying profile (temperature/time) is selected process-specifically. Suitable temperatures are in the range from 20 to 150° C., while suitable drying times are in the range from 0.1 to 60 minutes. The drying processes can be integrated into the continuous production process.

The cutting up of the substrates into discrete five-layer membrane-electrode units (MEUs) is generally carried out by means of conventional cutting devices, cutter punches or rotational knives. Both continuous and discontinuous procedures are possible.

1. Process for producing a five-layer membrane-electrode unit comprising an ionomer membrane, a first catalyst layer, a second catalyst layer, a first gas diffusion layer and a second gas diffusion layer, which comprises the steps:
a) coating of the two gas diffusion layers with catalyst,
b) perforation of at least one gas diffusion layer in a suitable grid,
c) lamination of the two gas diffusion layers with the ionomer membrane,
d) removal of the at least one pressed screen from the surface of the ionomer membrane and cutting-off of the membrane-electrode unit.

2. Process for producing a five-layer membrane-electrode unit comprising an ionomer membrane, a first catalyst layer, a second catalyst layer, a first gas diffusion layer and a second gas diffusion layer with the ionomer membrane forming a rim projecting beyond the gas diffusion layers, which comprises the steps:
a) coating of the first gas diffusion layer with catalyst ink in the form of a suitable pattern and subsequent drying,
b) coating of the second gas diffusion layer with catalyst ink in the form of a suitable pattern and subsequent drying,
c) perforation of the two gas diffusion layers in a grid suitable for the pattern,
d) lamination of the two perforated gas diffusion layers with the ionomer membrane,
e) removal of the two pressed screens on the front and reverse sides of the ionomer membrane and cutting-off of the membrane-electrode unit.

3. Process for producing a five-layer membrane-electrode unit comprising an ionomer membrane, a first catalyst layer, a second catalyst layer, a first gas diffusion layer and a second gas diffusion layer, with the first gas diffusion layer having a smaller area than the ionomer membrane and the second gas diffusion layer essentially matching the ionomer membrane, which comprises the steps:
a) coating of the first gas diffusion layer with catalyst ink in the form of a suitable pattern and subsequent drying,
b) coating of the second gas diffusion layer with catalyst ink over its entire area and subsequent drying,
c) perforation of the gas diffusion layer coated with catalyst in the form of a pattern in a grid suitable for the pattern,
d) lamination of the gas diffusion layers with the ionomer membrane,
e) removal of the pressed screen from one side of the ionomer membrane and cutting-off of the membrane-electrode unit.

4. Process for producing a five-layer membrane-electrode unit comprising an ionomer membrane, a first catalyst layer, a second catalyst layer, a first gas diffusion layer and a second gas diffusion layer, with the ionomer membrane forming a rim projecting beyond the gas diffusion layers, which comprises the steps:
a) coating of the first gas diffusion layer with catalyst ink in a suitable pattern and perforation of the gas diffusion layer,
b) lamination of the first gas diffusion layer with the moist catalyst layer onto the first side of the ionomer membrane,
c) drying of the three-layer structure,
d) coating of the second gas diffusion layer with catalyst ink in a suitable pattern and perforation of the gas diffusion layer,
e) lamination of the second gas diffusion layer with the moist catalyst layer onto the second side of the ionomer membrane,
f) drying of the five-layer structure,
g) removal of the pressed screens from both sides of the ionomer membrane (1) and cutting-off of the membrane-electrode unit.

5. Process for producing a five-layer membrane-electrode unit comprising an ionomer membrane, a first catalyst layer, a second catalyst layer, a first gas diffusion layer and a second gas diffusion layer, with the first gas diffusion layer having a smaller area than the ionomer membrane and the second gas diffusion layer essentially matching the ionomer membrane, which comprises the steps:
a) coating of the first gas diffusion layer with catalyst ink over its entire area,
b) lamination of the first gas diffusion layer with the moist catalyst layer onto the first side of the ionomer membrane,
c) drying of the three-layer structure,
d) coating of the second gas diffusion layer with catalyst ink in a suitable pattern and perforation of the gas diffusion layer,
e) lamination of the second gas diffusion layer with the moist catalyst layer onto the second side of the ionomer membrane,
f) drying of the five-layer structure,
g) removal of the pressed screen from the second side of the ionomer membrane and cutting-off of the membrane-electrode unit.

6. Process according to any of claim 1, wherein at least two of the process steps are carried out continuously and the ionomer membrane or at least one of the gas diffusion layers is present in tape form.

7. Process according to any of claim 1, wherein the pressed screen is reinforced prior to removal in order to prevent tearing.

8. Process according to any of claim 1, wherein the perforation of at least one gas diffusion layer is carried out either before or after coating with catalyst ink.

9. Process according to any of claim 1 which further comprises suitable after-treatment and/or cleaning steps.

10. Process according to any of claim 1, wherein the ionomer membrane comprises polymeric, perfluorinated sulphonic acid compounds, doped polybenzimidazoles, polyether ketones, polysulphones, composite membranes, ceramic membranes or other proton-conducting materials, has a thickness in the range from 10 to 200 μm and optionally has a supporting or carrier film.

11. Process according to any of claim 1, wherein the gas diffusion layers comprise carbon-based materials such as graphitized or carbonized carbon fibre papers, woven carbon fibre fabrics or carbon fibre nonwovens and optionally have a microlayer.

12. Process according to any of claim 1, wherein the coating of the gas diffusion layers is effected by means of screen printing, offset printing, transfer printing, doctor blade coating, spraying, flexo printing, roller coating or similar methods.

13. Process according to any of claim 1, wherein the perforation of the gas diffusion layers is carried out using perforation tools such as knives, impact cutters, stamping tools, perforation rollers, etc.

14. Process according to any of claim 1, wherein the perforation grid consists of perforations having a width (b) in the range from 5 to 20 mm and webs having a width (c) in the range from 1 to 5 mm.

15. Process according to any of claim 1, wherein lamination is carried out by means of rollers or presses at temperatures in the range from 90 to 200° C. and pressures in the range from 50 to 300 N/cm².

16. Process according to any of claim 1, wherein the catalyst layers comprise the precious metals platinum, ruthenium, iridium, osmium, gold, palladium, silver, rhodium or mixtures or alloys thereof and have a loading of from 0.05 to 10 mg of precious metal/cm².

17. Process according to any of claim 1, wherein drying is carried out by means of hot air drying, infrared drying, microwave drying, plasma processes and/or combinations thereof and the drying temperatures are in the range from 20 to 150° C., and the drying times are in the range from 0.1 to 60 minutes.

18. An electrochemical device comprising a membrane electrode unit produced in accordance with claim 1.

19. The electrochemical device of claim 18 wherein the device is a PEM fuel cell, a direct methanol fuel cell (DMFC), an electrolyser or a sensor.
